(19) United States
(12) Patent Application Publication
(10) Pub. No.: US 2010/0057991 A1
(43) Pub. Date: Mar. 4, 2010

(54) METHOD FOR CONTROLLING STORAGE SYSTEM, STORAGE SYSTEM, AND STORAGE APPARATUS

(75) Inventors: Masahiro YOSHIDA, Kawasaki (JP); Tadashi MATSUMURA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/512,330

(22) Filed: Jul. 30, 2009

(30) Foreign Application Priority Data
Aug. 29, 2008 (JP) 2008-222115

(51) Int. Cl. G06F 12/00; G06F 1/26

(52) U.S. Cl. 711/114; 713/300; 711/E12.001

(57) ABSTRACT

A storage apparatus comprising a logical volume composed of a plurality of storage media includes an access instruction receiving section receiving, from a server, an instruction to access the logical volume, an access executing section executing an access to the logical volume based on the access instruction, and a power supply control section which, if the logical volume to be accessed is inaccessible, changes a power supply status of a storage medium corresponding to redundancy of the logical volume.

### CROSS-REFERENCE TO RELATED APPLICATIONS

This application is based upon and claims the benefit of priority of the prior Japanese Patent Application No. 2008-222115, filed on Aug. 29, 2008, the entire contents of which are incorporated herein by reference.

### BACKGROUND

1. Field

The present invention relates to a technique for controlling a power supply to a logical volume composed of a plurality of storage media in a storage system.

2. Description of the Related Art

With computerized business operations and relevant laws and regulations, there has been a growing demand for data storage apparatuses to which electronic mails, materials, and documents are all manageably saved. Conventional mass storage apparatuses include tape apparatuses. However, the tape apparatuses are poor in readiness. Thus, storage apparatuses have been mainly utilized which are excellent in readiness and which are equipped with hard disks capable of dealing with a large volume of data.

There has also been a desire for providing green products friendly to the global environment and products intended to protect resources with environment protection by, for example, taking energy saving into account. The power consumption of the storage apparatus increases in proportion to the number of disks mounted in the storage apparatus. Thus, a power saving process has been carried out in which a motor for a non-accessed disk is turned off as long as a server does not access the disk.

The power saving process for the storage apparatus requires both reducing the power consumption of the disks and ensuring quick responses to accesses.

In a known conventional technique meeting this requirement, if RAIDs (Redundant Arrays of Inexpensive Disks) are configured in the storage apparatus, one of the disks included in the RAIDs is turned off to save power. Furthermore, a number of disks required to respond to accesses are kept on to simultaneously ensure quick responses to sudden accesses.

In a conventional technique described in Japanese Patent Laid-Open No. 2001-14107, a technique is disclosed in which, when a host issues a request to cancel a standby state to a hard disk drive in a standby state, a power supply recovery time is predicted which is required to recover the hard disk drive from the standby state to make the hard disk drive available. The host is then notified of the power supply recovery time and optimizes a schedule such that the host executes a task that is completed within this time interval before the hard disk drive is started up.

However, the conventional technique turning off only one of the disks included in the RAIDs is not significantly effective for reducing the power consumption. If a reduction in power consumption is emphasized, turning off all of the disks included in the RAIDs which are non-accessed is the best method for reducing the power consumption. However, for the storage apparatus configured to emphasize the power consumption reduction, the performance of responses to sudden accesses from the host needs to be taken into account. Turning on a disk that has been off requires several tens of seconds to several minutes, disadvantageously degrading the response performance.

To prevent the possible degradation of the response performance is an unavoidable objective associated with the reduction in power consumption. Applications that access the storage apparatus cannot conventionally determine the power control status of the storage apparatus. Thus, when the disk is in a power saving status, a long time may be required to activate and thus access the disk. In this case, timeout may occur, resulting in an error in the access process.

### SUMMARY

According to an aspect of the embodiment, a storage apparatus having a logical volume composed of a plurality of storage media includes an access instruction receiving section receiving, from a server, an instruction to access the logical volume, an access executing section executing an access to the logical volume based on the access instruction, and a power supply control section which, if the logical volume to be accessed is inaccessible, changes a power supply status of a storage medium corresponding to redundancy of the logical volume.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

The above-described embodiments of the present invention are intended as examples, and all embodiments of the present invention are not limited to including the features described above.

### BRIEF DESCRIPTION OF THE DRAWINGS

FIG. 1 illustrates a hardware system configuration of the present embodiment;

FIG. 2 illustrates a functional configuration of the present embodiment implemented in the hardware system configuration in FIG. 1;

FIG. 3 illustrates data configuration of software cooperation configuration information;

FIG. 4 illustrates the software cooperation configuration information;

FIG. 5 illustrates a power saving mode (ECO mode) control process executed by a storage apparatus 201;

FIG. 6 illustrates a software-side monitoring process control operation performed on a host server apparatus 202 side;

FIG. 7 illustrates an access accepting process control operation performed on the host server apparatus 202 side;

FIG. 8 illustrates a motor activation monitoring process control operation performed on the host server apparatus 202 side;

FIG. 9 illustrates a motor activation instruction notification accepting process control operation performed on the storage apparatus 201 side;

FIG. 10 illustrates a motor activation monitoring process control operation performed on the storage apparatus 201 side;

FIG. 11 illustrates a periodic motor-off monitoring process control operation performed on the host server apparatus 202 side;

FIG. 12 illustrates a motor-off notification accepting process control operation performed on the storage apparatus 201 side;

FIG. 13 illustrates a motor-off determining process control operation performed on the storage apparatus 201 side; and

FIG. 14 illustrates a motor-off monitoring process control operation performed on the storage apparatus 201 side.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

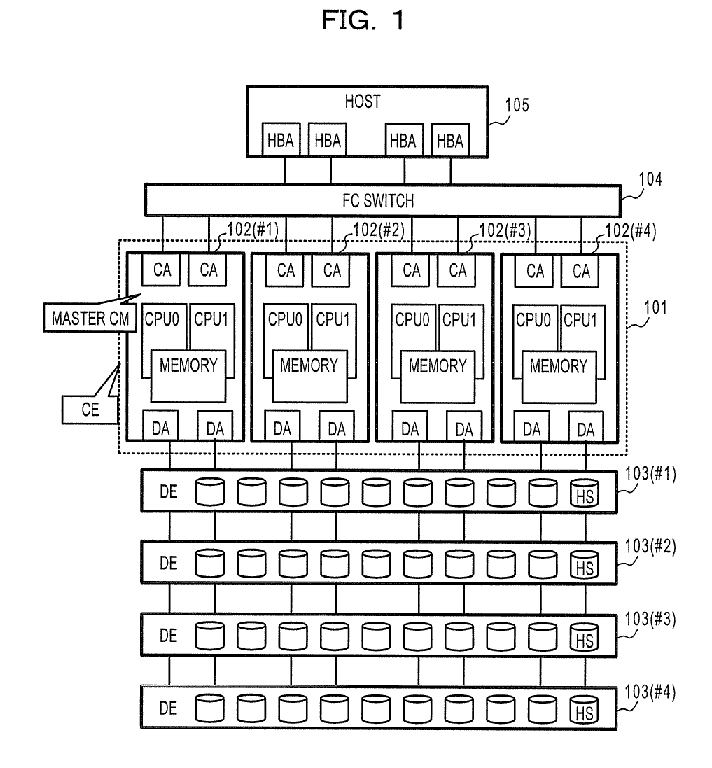

FIG. 1 illustrates a configuration of the hardware system of a storage system according to an embodiment of the present invention. A storage apparatus includes a controller enclosure (CE) 101 in which a plurality of control modules (CM) 102 (in FIG. 1, four control modules 102 (#1) to 102 (#4)) are stored, and a plurality of disk enclosures (DEs) 103 (in FIG. 1, four enclosures 103 (#1) to 103 (#4)) in which a plurality of disk storage media each containing a hot spare disk (HS) are stored. RAIDs are composed of a plurality of disk storage media.

Channel adaptors (CA) in each of the CMs 102 in the storage apparatus are connected to host bus adapters (HBAs) in a host server apparatus (HOST) 105 via a fibre channel (FC) switch 104. The host server apparatus 105 can be connected to a plurality of storage apparatuses via the FC switch 104.

Each of the DEs 103 are connected directly to a corresponding one of the CMs 102 via a disk adapter (DA), or connected to the corresponding CM 102 via a router device (not shown in the drawings).

The CM 102 performs disk accesses, power supply control, and the like. The CM 102 includes, besides the DAs and CAs, two CPUs (CPU0 and CPU1) (Central Processing Units) and a memory.

During normal operation, only one (for example, 102 (#1) in FIG. 1) of the plurality of CMs 102 operates as a master CM, while the others (for example, 102 (#2), 102 (#3), and 102 (#4) in FIG. 1) operate as slave CMs. The master CM transmits and receives commands and responses to and from the host server apparatus 105 and controls accesses to the DE 103 for which the master CM is responsible. Each of the slave CMs only controls accesses to the DE 103 for which the CM is responsible, in accordance with instructions from the master CM.

Thus, redundancy is ensured for both CMs 102 and DE 103.

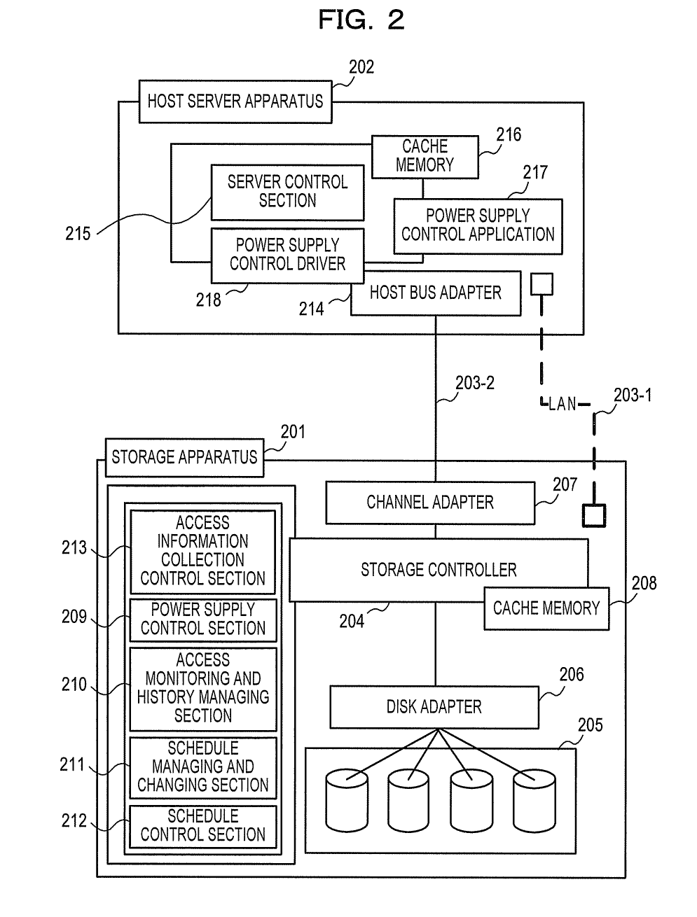

FIG. 2 illustrates the functional configuration of the storage system according to the embodiment which is implemented in the hardware system configuration in FIG. 1. A storage apparatus 201 (corresponding to 101 to 103 in FIG. 1) is connected to a host server apparatus 202 (corresponding to 105 in FIG. 1) via a LAN 203-1 or a channel path 203-2.

In the storage apparatus 201, the CM 102 in FIG. 1 has functional sections including a storage controller 204, a disk adapter 206, a channel adapter 207, and a cache memory 208. The DE 103 in FIG. 1 corresponds to a disk enclosure 205.

The storage controller 204 includes not only a functional section that executes a command process but also a power supply control section 209, an access monitoring and history managing section 210, a schedule managing and changing section 211, a schedule control section 212, and an access information collection control section 213.

The host server apparatus 202 includes a server control section 215 that controls the whole server, a cache memory 216, and a host bus adapter 214. The host server apparatus 202 further includes a power supply control application 217 and a power supply control driver 218 which cooperate with the power supply control section 209 and the like in the storage apparatus 201 in controlling power saving in the disk enclosure 205. This will be described below.

Based on the status of accesses to a logical volume constructed on disks in the disk enclosure 205 as well as a power supply control schedule, the power supply control section 209 executes a determining process for a reduction in power consumption to controllably turn on and off a motor for a target disk. Furthermore, based on the results of monitoring by the access monitoring and history managing section 210, the power supply control section 209 performs motor off control if a disk is detected which has been inoperative during a given time interval. The power supply control section 209 further performs motor-on control in association with a rapid increase in load.

The access monitoring and history managing section 210 monitors the access status for each disk in the disk enclosure 205, for each RAID group, and for each logical volume based on date and time to create a monitoring history.

The schedule managing and changing section 211 is a control section that manages and changes the power supply control schedule, based on which determination is made for power saving. The schedule managing and changing section 211 creates an optimized schedule based on a monitoring history created by the access monitoring and history managing section 210.

The schedule control section 212 controls the power supply control schedule for the process of turning on and off the motors for the disks in the disk enclosure 205. The schedule control section 212 constantly updates the schedule optimized during a given time interval so as to reflect an operation status with a user specified power supply control schedule taken into account.

An access information collection control section 213 operates in cooperation with the power supply control section 209, the access monitoring and history managing section 210, the schedule managing and changing section 211, and the schedule control section 212. Every time the storage apparatus 201 is accessed by the host server apparatus 202, the access information collection control section 213 counts up a corresponding one of access counters for the respective host server apparatuses 202, a corresponding one of access counters for the respective disks, a corresponding one of access counters for the respective RAID groups, and a corresponding one of access counters for the respective logical volumes.

The above-described access counters, the power supply control schedule, and the access history are stored in the memory in the CM 102 in FIG. 1 and referenced by the above-described control sections.

The operation of the present embodiment configured as described above will be described below.

Normal Operation

The storage apparatus 201 is normally configured with redundancy taken into account. Thus, the CM 102 and the disk enclosure 205, which control the storage apparatus 201, are at least duplexed. The RAID group is composed of the disks in the disk enclosures 205 mounted in the storage apparatus 201. The RAID group is composed of the plurality of disks. For normal operation, power consumption is not taken into account. Thus, all the mounted disks are operated with the respective motors on.

Power Consumption Reducing Process for the Storage Apparatus 201 (Operation and Schedule Control)

In the storage apparatus 201, during normal operation, the access information collection control section 213 acquires access information (performance information) for each disk, for each RAID group (hereinafter referred to as an “RLU”), and for each logical volume at given time intervals. For example, a technique disclosed in Japanese Patent Laid-Open No. 2008-250945 can be used for the processing from an information collecting process through creation of a power supply control schedule.

Process for Optimizing a Response to an Unscheduled Host Access

To reduce the power consumption, the storage apparatus 201 controls the motor for the single target disk or the motors for the disks included in the target RAID group based on the acquired access information.

When the motor is turned off, the next motor-on operation is classified into two types.

1. Motor-on operation performed before an access based on the access information and schedule management.

2. Motor-on operation resulting from an access that was not predicted in the access information and schedule management.

The problem to be solved by the present embodiment corresponds to case 2.

In case 1, since the access is predicted, the motors for the target disks or the motors for the disks included in the target RAID group are turned on before the access, causing no problem at a host access.

In case 2, the access is not predicted by the storage apparatus 201. Thus, the motor-on process is normally executed when the access occurs. Consequently, the access process is delayed until the motor-on process is completed. The motor-on process normally requires several tens of seconds to several minutes owing to the number of disks for which the corresponding motors are turned on, the limit on the capacity of the power supply to the apparatus, and the like. As a result, a response may be delayed or a host path may be disconnected.

The following configuration is adopted to solve the problems with case 2, and to optimize the control of the power supply to the RAID group in the storage apparatus 201.

In the case where the host server apparatus 202 and the storage apparatus 201 are connected together via the LAN 203-1, the power supply control application 217 captures a storage access made by a high-order application operating in the host server apparatus 202 as well as a corresponding response from the storage apparatus 201. The power supply control application 217 cooperates with the storage apparatus 201 in appropriately controlling power supply.

In the case where the host server apparatus 202 and the storage apparatus 201 are connected together via a channel path 203-2, the power supply control driver 218 captures a storage access made by a high-order application operating in the host server apparatus 202 as well as a corresponding response from the storage apparatus 201. The power supply control driver 218 cooperates with the storage apparatus 201 in appropriately controlling power supply.

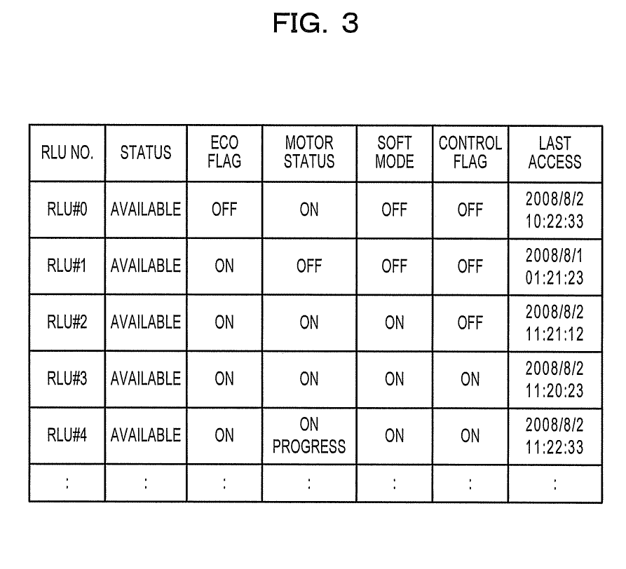

In the present embodiment, to enable the host server apparatus 202 and the storage apparatus 201 to cooperate efficiently in the power supply control process, the memory in the CM 102 in FIG. 1 holds software cooperation configuration information having a data configuration shown in FIG. 3.

In FIG. 3, RAID group numbers are stored in an “RLU no” field.

The status of the target RAID group is stored in a “Status” field. “Available” indicates a normal status. “Broken” indicates that an error is occurring to prevent the access. “Exposed” indicates an accessible status in which an error is occurring and the system has no redundancy. “Rebuild” indicates that the system is being recovered by a maintenance component. In the power supply control, the motors can be turned off only for RAID groups with the “Status” field value indicating the “normal” status. The motors are prevented from being turned off in the cases of “Broken”, “Exposed”, and “Rebuild”.

Information indicating whether or not a power saving mode is applied to the target RAID group is stored in an “ECO Flag” field. “Off” indicates the nonuse of the power saving mode. “On” indicates the use of the power saving mode. If the “ECO Flag” field value is “On”, the motor-off/on control is permitted. If the “ECO Flag” field value is “Off”, the motor-off/on control is not permitted (the motor is always on).

The motor activation status of the target RAID group is stored in a “Motor Status” field. “On” means that the motors are in operation. “On Progress” means that an operation process is in progress. “Off” means that the motors are stopped. “Off Progress” means that a stop process is in progress.

A setting mode indicating whether or not to operate in conjunction with software power saving control by the host server apparatus 202 is stored in a “Soft Mode” field. “On” means that the apparatus is operating in conjunction with the host-side software. “Off” means that the apparatus is not operating in conjunction with the host-side software (power saving control inherent in the storage apparatus 201).

The status of the power saving control by the host-side software is stored in a “Control Flag” field. “Off” means that the control is not being applied. “On” means that the control is being applied.

The date and time (hour, minute, and second) of the last access are stored in a “Last Access” field.

Based on the above-described definitions, for example, the data configuration example in FIG. 3 indicates the following power supply control statuses.

For RLU#0, power saving is inactive. The motors are on.

For RLU#1, power saving is active. The software control is inactive. The motors are off.

For RLU#2, power saving is active. The software control is active. The software control is not being applied. The motors are on.

For RLU#3, power saving is active. The software control is active. The software control is being applied. The motors are on.

For RLU#4, power saving is active. The software control is active. The software control is being applied. The motor-on process is in progress.

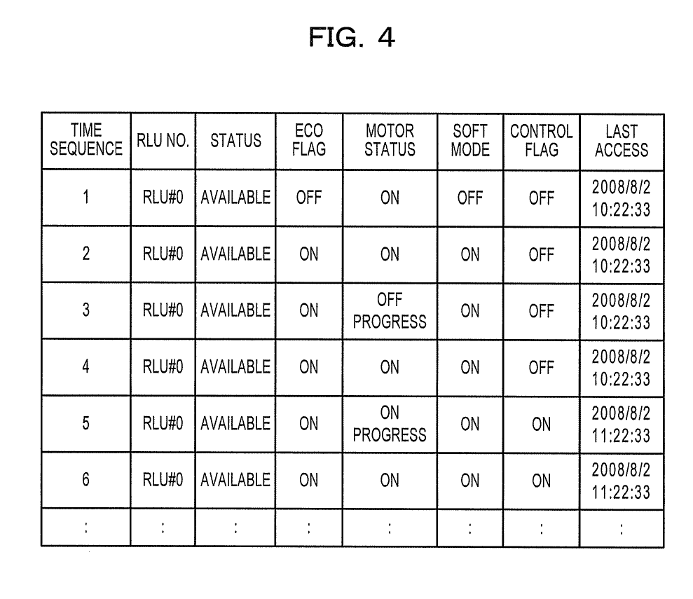

Now, only the RLU#0 is noted. If the contents of the registration for the RLU#0 vary as shown in time sequences 1 to 6 in FIG. 4, for example, this indicates that the power supply control status according to the present embodiment varies as follows.

1. For the RLU#0, power saving is inactive. The motors are on.

2. The RLU#0 is set such that ECO Flag=On and Soft Mode=On.

3. The software control has not been applied and no access has been made for a certain time. Then, the motor-off process is started.

4. The motor-off process is completed to turn off the motors.

5. An advance notification of an access is received from the software. Control Flag is set to On and Last Access is set to the time of the notification to start the motor-on process.

6. The motor-on process is completed to turn on the motors.

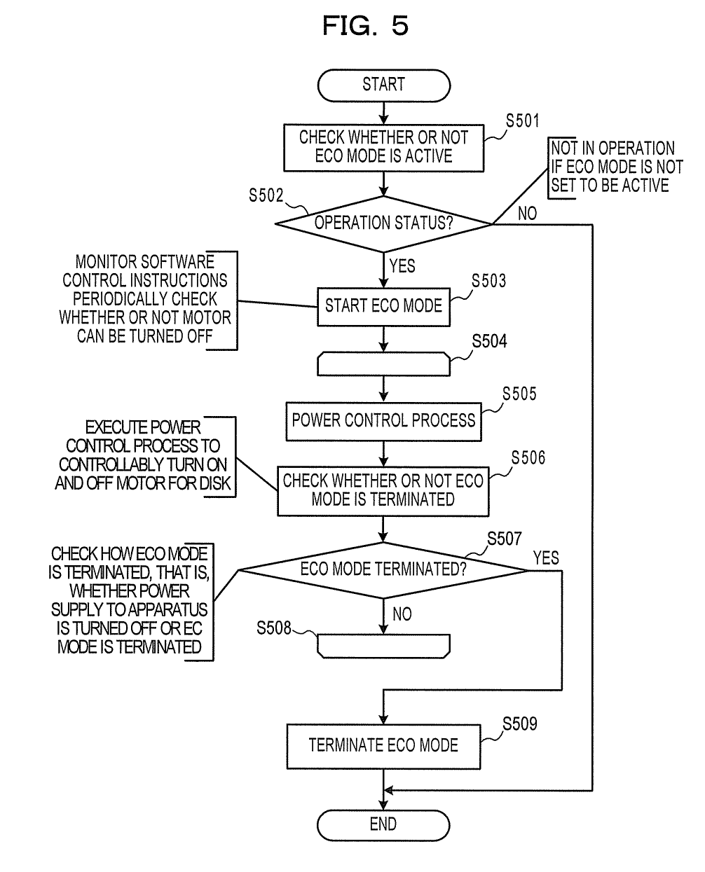

The process in which the power supply control application 217 and the storage apparatus 201 cooperate using the software cooperation configuration information will be sequentially described with reference to operational flow charts in FIGS. 5 to 14.

First, FIG. 5 illustrates a power saving mode (ECO mode) operation control process executed by the power supply control section 209 (see FIG. 2) in the storage apparatus 201.

The power supply control section 209 checks whether or not the ECO mode is set to be active in the storage apparatus 201 (operation S501).

Upon determining that the ECO mode is not set to be active, the power supply control section 209 terminates the process shown in the operational flowchart in FIG. 5. The power supply control section 209 then performs the above-described normal operation. All the mounted disks are set in the motor-on status (the determination in Operation S502 is NO).

Upon determining that the ECO mode is set to be active (the determination in Operation S502 is YES), the power supply control section 209 starts the ECO mode (Operation S503).

Thereafter, the power supply control section 209 periodically and repeatedly executes a series of process steps from Operation S505 to Operation S507 via Operations S504 and S508.

In each repetition, the power supply control section 209 first executes the above-described power control process as a “process for reducing the power consumption of the storage apparatus 201 (operation and schedule control)” (Operation S505). Thus, the motors are controllably turned on and off based on the schedule.

Then, the power supply control section 209 checks whether or not an instruction to terminate the ECO mode has been given (Operation S506). Upon determining that the instruction has not been given, the power supply control section 209 continues the periodic monitoring (the determination in Operation S507 is NO).

On the other hand, upon determining that the instruction to terminate the ECO mode has been given, the power supply control section 209 stops the ECO mode (the determination in Operation S507 is YES→S509).

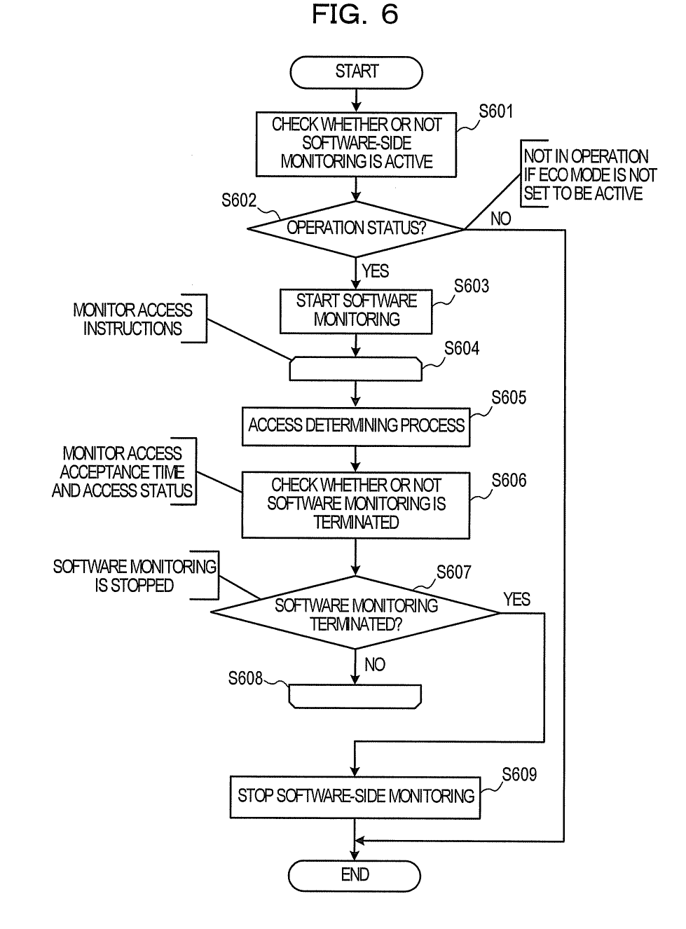

FIG. 6 illustrates a software-side monitoring process control operation in which the power supply control application 217 (see FIG. 2) in the host server apparatus 202 determines whether or not a high-order application being executed in the host server apparatus 202 is accessing the storage apparatus 201.

The power supply control application 217 checks whether or not the software-side monitoring process is set to be active (Operation S601).

Upon determining that the software-side monitoring process is not set to be active, the power supply control application 217 terminates the process shown in the operational flowchart in FIG. 6 (the determination in Operation S601 is NO).

Upon determining that the software-side monitoring process is set to be active (the determination in Operation S601 is YES), the power supply control application 217 starts a software-side monitoring process (Operation S602). The power supply control application 217 periodically and repeatedly executes a series of process steps from Operation S605 to Operation S607 via Operations S604 and S608.

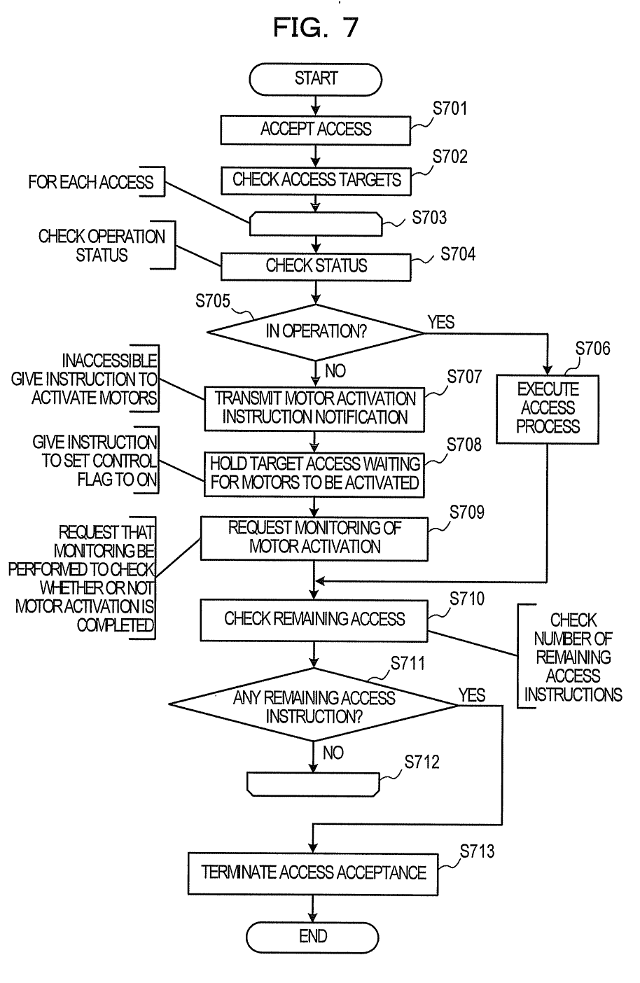

In each repetition, the power supply control application 217 first monitors the status of accesses from the high-order application and the time of the accesses (Operation S605). Here, if the high-order application makes an access, the operational flowchart in FIG. 7 described below is carried out.

Then, the power supply control application 217 checks whether or not an instruction to terminate the software-side monitoring process has been given (Operation S606). Upon determining that the instruction has not been given, the power supply control application 217 continues the periodic monitoring (the determination in Operation S607 is NO).

On the other hand, upon determining that the instruction to terminate the software-side monitoring process has been given, the power supply control application 217 stops the software-side monitoring process (the determination in Operation S607 is YES→S609).

FIG. 7 illustrates an access accepting process control operation in which in response to sensing of an access from the high-order application (Operation S605 in FIG. 6), the power supply control application 217 in the host server apparatus 202 accepts the access.

First, the power supply control application 217 starts an access accepting process (Operation S701). The power supply control application 217 checks the access target storage apparatus 201 and RAID group (Operation S702).

Then, the power supply control application 217 repeatedly executes a series of process steps from Operation S704 to Operation S711 via Operations S703 and S712, on each of the accepted accesses.

In each repetition, the power supply control application 217 first performs a status check to determine whether or not the target RAID group is in operation (Operation S704). The status check is achieved by checking the value of the “Motor Status” field for the corresponding RLU (RAID group) contained in the software cooperation configuration information held in the storage apparatus 201.

Upon determining that the target RAID group is in operation (“Motor Status” field value=“On”)(the determination in Operation S705 is YES), the power supply control application 217 executes an access process on the storage apparatus 201 (Operation S706). The power supply control application 217 then shifts to processing of the next RAID group (Operation S706→S710).

Upon determining that the target RAID group is not in operation (“Motor Status” field value=value other than “On”)(the determination in Operation S705 is NO), the power supply control application 217 issues a motor activation instruction notification for the target RAID group, to the power supply control section 209 of the storage apparatus 201 (Operation S707) because no access is possible.

Subsequently, the power supply control application 217 gives an instruction to change the value of the “Control Flag” field for the RAID group to “On” (see FIG. 3). The power supply control application 217 then internally holds information on the target access indicating that the RAID group is ready to be activated (Operation S708).

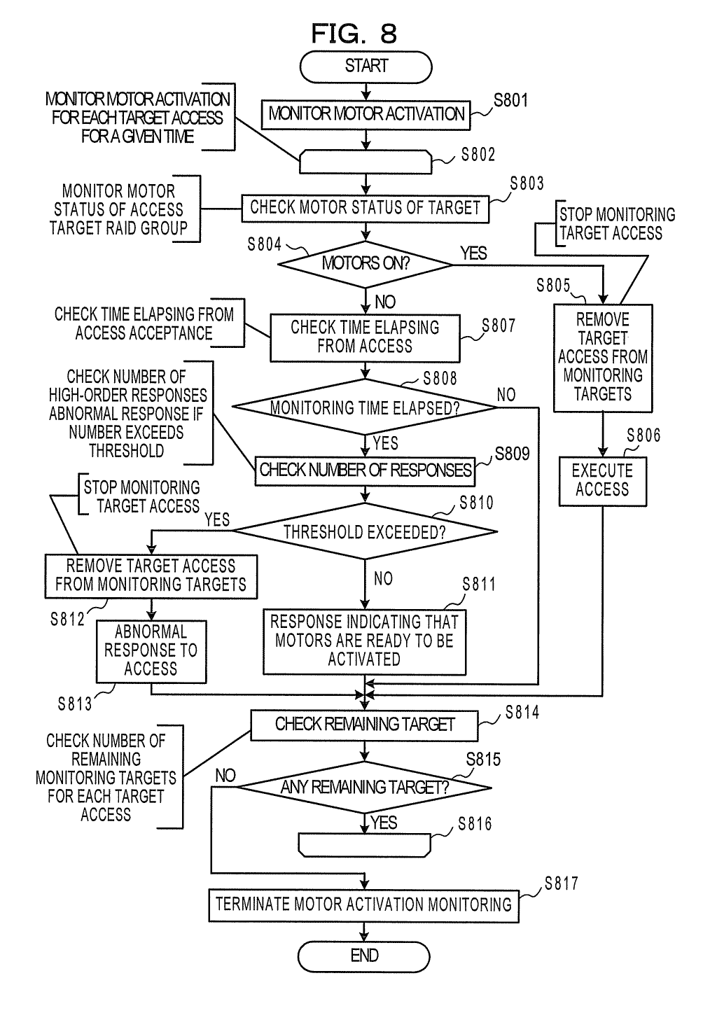

Then, the power supply control application 217 requests a process of performing monitoring to determine whether or not the motor activation has been completed (Operation S709), in connection with a motor activation monitoring process shown in the operational flowchart in FIG. 8 described below.

Finally, the power supply control application 217 checks whether or not any other access from the high-order application to be processed remains (Operation S710). Upon determining that any other access remains to be processed (the determination in Operation S711 is YES), the power supply control application 217 repeatedly executes the above-described series of accepting process steps (Operation S712).

Upon determining that no other access remains to be processed (the determination in Operation S711 is NO), the power supply control application 217 terminates the access accepting process (Operation S713).

FIG. 8 illustrates a motor activation monitoring process control operation in which the power supply control application 217 in the host server apparatus 202 fulfils the motor activation monitoring request issued in Operation S709 in FIG. 7 in connection with each access accepted through the access accepting process illustrated in the operational flowchart in FIG. 7.

First, the power supply control application 217 starts a monitoring process (Operation S801). The power supply control application 217 repeatedly executes a series of process steps from Operations S813 to S815, via Operations S802 and S816. The power supply control application 217 executes the process steps on each of the target accesses corresponding to the accepted motor activation monitoring requests so that the same target access is processed at least once and until each of the target accesses is removed from the monitoring targets. The power supply control application 217 thus monitors each target access for a given time from the beginning of the access.

In each repetition, the power supply control application 217 first checks the motor status of the RAID group in the storage apparatus 201 to be accessed (Operation S803). The check is achieved by inquiring about the value of the “Motor Status” field for the corresponding RLU (RAID group) in the software cooperation configuration information held by the target storage apparatus 201.

Upon determining, as a result of the check, that the corresponding motor is on (the determination in Operation S804 is YES), the power supply control application 217 removes the target access from the monitoring targets (Operation S805). The power supply control application 217 then executes the access (Operation S806). Thereafter, the power supply control application 217 shifts to processing of the next monitoring target (Operation S806→Operation S814).

Upon determining, as a result of the check, that the corresponding motor is not on (the determination in Operation S804 is NO), the power supply control application 217 checks whether or not the time elapsing from the acceptance of the target access is equal to a predetermined monitoring time (Operation S807).

Upon determining that the elapsed time is not equal to the predetermined monitoring time (the determination in Operation S808 is NO), the power supply control application 217 shifts to processing of the next monitoring target (Operation S808→Operation S814).

Upon determining that the elapsed time is equal to the predetermined monitoring time, the power supply control application 217 checks the number of responses to the high-order application in Operation S811 from the high-order application (Operation S809).

Upon determining that the number of responses has not exceeded a predetermined threshold (the determination in Operation S810 is NO), the power supply control application 217 responds to the high-order application by notifying the high-order application that the motors are ready to be activated (Operation S811).

Upon determining that the number of responses has exceeded the predetermined threshold (the determination in Operation S810 is YES), the power supply control application 217 removes the target access from the monitoring targets (Operation S812). The power supply control application 217 responds to the high-order application by notifying the high-order application of an access error (Operation S813).

After the processing in Operation S806, S811, or S813, the power supply control application 217 checks whether or not any other target access remains to be monitored (Operation S814). Upon determining that any other target access remains to be processed (the determination in Operation S815 is YES), the power supply control application 217 continues to monitor the next monitoring target access (including itself) (Operation S816). Upon determining that no other access remains to be processed (the determination in Operation S815 is NO), the power supply control application 217 terminates the monitor operation monitoring process (Operation S817).

The cooperative process is executed as described above. That is, when the high-order application issues an access to the storage apparatus 201, the motors for the disks in the RAID group in the target storage apparatus 201 may be off owing to the power saving control. Then, the power supply control application 217 in the host server apparatus 202 can appropriately respond to the high-order application by notifying the high-order application that the motors are ready to be activated. Thus, the high-order application can incorporate an operation of appropriately dealing with the power saving control, into the program.

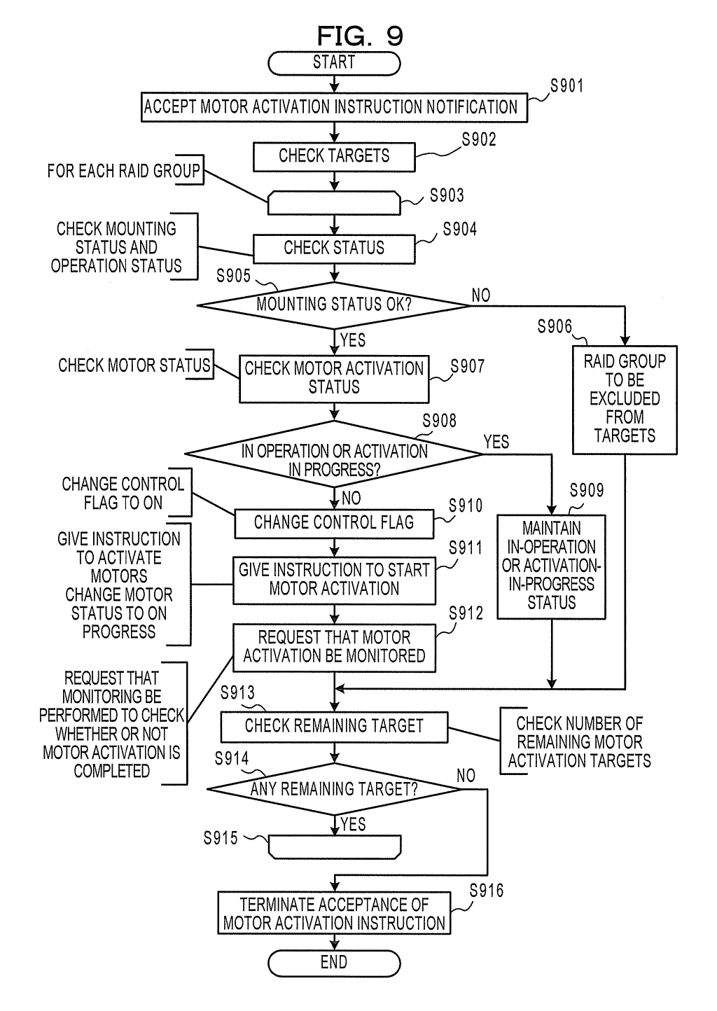

FIG. 9 illustrates a motor activation instruction notification accepting process control operation to give an instruction to turn on the motors for the disks belonging to the RAID group. The control operation is executed by the power supply control section 209 (see FIG. 2) in the storage apparatus 201. The control operation is executed upon accepting a motor activation instruction notification relating to any of the RAID groups in the storage apparatus 201 as a result of the access accepting process executed by the power supply control application 217 in the host server apparatus 202 as illustrated in FIG. 7.

First, the power supply control section 209 starts a motor activation instruction notification accepting process (Operation S901). The power supply control section 209 checks the RAID groups specified in the notification (Operation S902).

Then, the power supply control section 209 executes repeatedly a series of process steps from Operations S904 to S914 via Operations S903 and S915 for each of the RAID groups corresponding to the accepted notification. The power supply control section 209 thus executes a series of control process steps to give an instruction to turn on the motors for the disks belonging to each of the RAID groups.

In each repetition, the power supply control section 209 first checks the mounting status and operation status of the disks belonging to the target RAID group (Operation S904). The check is achieved by checking whether or not the value of the “Status” field for the corresponding RLU (RAID group) in the software cooperation configuration information held by the storage apparatus 201 is “Available”.

Upon determining that the mounting status and the like are not OK (the determination in Operation S905 is NO), the power supply control section 209 determines that the RAID group be excluded from the targets to skip the accepting process (Operation S906). The power supply control section 209 then shifts to processing of another target RAID group (Operation S906→S913). In this case, in the motor activation monitoring process executed by the power supply control application 217 in the host server apparatus 202 as illustrated in the operational flowchart in FIG. 8, the determination in Operation S804 for the RAID group is not YES. The monitoring time elapses and exceeds a threshold in Operation S810. Thus, in Operation S813, the power supply control application 217 determines an access error.

Upon determining that the mounting status and the like are OK (the determination in Operation S905 is YES), the power supply control section 209 checks the operation status of the motors for the disks belonging to the target RAID group (Operation S907). The check is achieved by checking the value of the “Monitor Status” field for the corresponding RLU (RAID group) in the software cooperation configuration information held by the storage apparatus 201.

Upon determining, as a result of the check, that the motors for the target RAID group are in operation (“Motor Status” field value=“On”) or an activation process is in progress (“Motor Status” field value=“On Progress”) (the determination in Operation S908 is YES), the power supply control section 209 maintains this status (Operation S909). The power supply control section 209 shifts to processing of another target RAID group (Operation S909→S913).

Upon determining, as a result of the check, that the motors for the target RAID group are not in operation or the activation process is not in progress (the determination in Operation S908 is NO), the power supply control section 209 first changes the value of the “Control Flag” field for the corresponding RLU (RAID group) in the software cooperation configuration information, to “On” in order to activate the motors for the target RAID group (Operation S910).

Then, the power supply control section 209 gives an operation start instruction to the motors belonging to the target RAID group. The power supply control section 209 further changes the value of the “Motor Status” field for the corresponding RLU (RAID group) in the software cooperation configuration information, to “On Progress” (Operation S911). Thus, an activation process is executed on the motors.

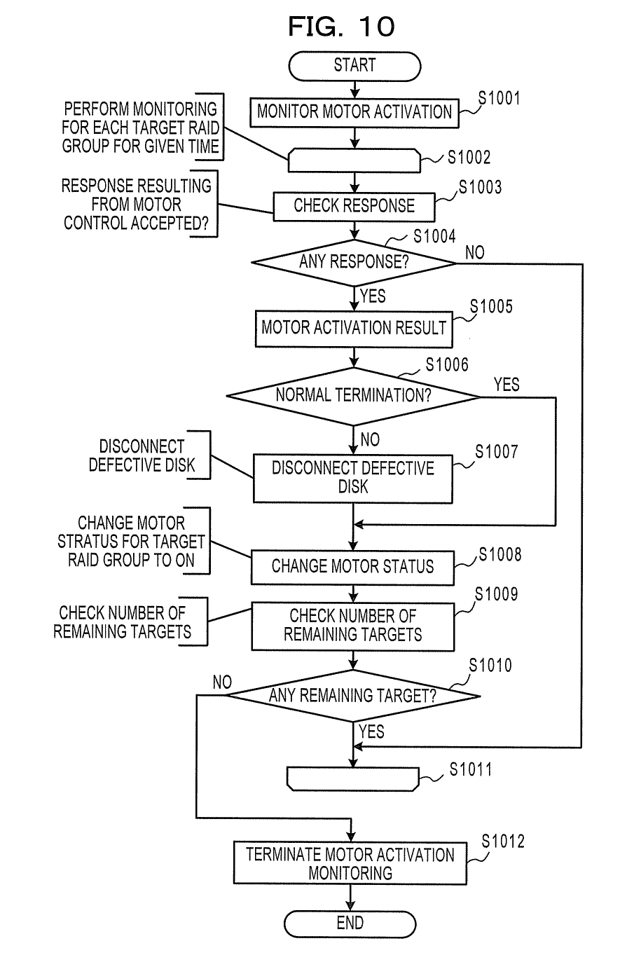

Moreover, the power supply control section 209 requests the appropriate component to perform monitoring to check whether or not the activation of the motors has been completed (Operation S912), in connection with a motor activation monitoring process illustrated in FIG. 10 described below.

After the processing in Operation S906, S909, or S912, the power supply control section 209 checks whether or not any other target RAID group remains to be processed (Operation S913). Upon determining that any other target RAID group remains to be processed (the determination in Operation S914 is YES), the power supply control section 209 continues to process the next target RAID group (Operation S915). Upon determining that no other target RAID group remains to be processed (the determination in Operation S914 is NO), the power supply control section 209 terminates the process of accepting the motor activation instruction notification (Operation S916).

FIG. 10 illustrates a motor activation monitoring process control operation in which the power supply control section 209 in the storage apparatus 201 processes a response resulting from the motor control performed according to the motor activation start instruction issued in Operation S911 in FIG. 9 in association with the motor activation instruction notification accepted in the motor activation instruction notification accepting process illustrated in FIG. 9.

First, the power supply control section 209 starts a motor activation monitoring process (Operation S1001). The power supply control section 209 repeatedly executes a series of process steps from Operations S1003 to S1010, via Operations S1002 and S1011, on each of the specified target RAID groups so that the same target RAID group is processed at least once for a given time. The power supply control section 209 thus monitors the disks in each target group for a given time.

In each repetition, the power supply control section 209 first checks whether or not a response has been obtained from the motor control function for the disks belonging to the target RAID group (Operation S1003).

Upon determining, as a result of the check, that the response has not been accepted (the determination in Operation S1004 is NO), the power supply control section 209 shifts to processing of the next monitoring target (Operation S1011).

Upon determining, as a result of the check, that the response has been accepted (the determination in Operation S1004 is YES), the power supply control section 209 receives the result of the motor activation from the motor control function to determine the contents of the result (Operation S1005).

As a result, upon determining that the motor activation process has failed to complete normally (the determination in Operation S1006 is NO), the power supply control section 209 removes the defective disk from the processing targets. The power supply control section 209 further changes the value of the “Status” field for the corresponding RLU (RAID group) in the software cooperation configuration information held in the storage apparatus 201, to “Exposed” indicating the presence of the defective disk, if a hot spare disk is not present in the storage apparatus. Furthermore, if a hot spare disk is present, the power supply control section 209 changes the value to “Rebuild” indicating that a recovery process is executed using the redundant normal disk (Operation S1007).

Upon determining that the motor activation process has completed normally (the determination in Operation S1006 is YES), the power supply control section 209 changes the value of the “Motor Status” field for the corresponding RLU (RAID group) in the software cooperation configuration information, from “On Progress” indicating that the activation process is in progress to “On” indicating that the motors are in operation (Operation S1008).

Even after the processing of the defective disk in Operation S1007, the power supply control section 209 changes the value of the “Motor Status” field to “On” in association with the specifications of the system to which the present embodiment is applied. However, since the value of the “Status” field is “Broken”, “Exposed”, or “Rebuild” (see Operation S1007), the defective disk can be recognized.

Finally, the power supply control section 209 checks whether or not any other target RAID group remains to be monitored (Operation S1009). Upon determining that another monitoring target remains to be processed (the determination in Operation S1010 is YES), the power supply control section 209 continues to monitor the next monitoring target RAID group (including itself) (Operation S1011). Upon determining that no other monitoring target remains to be processed (the determination in Operation S1010 is NO), the power supply control section 209 terminates the monitor operation monitoring process (Operation S1012).

The cooperative process is executed as described above. That is, when the high-order application in the host server apparatus 202 issues an access to the storage apparatus 201, the motors for the disks in the target RAID group may be off owing to the power saving control. Then, the power supply control section 209 of the storage apparatus 201 can appropriately controllably activate the motors based on the motor activation instruction from the host server apparatus 202.

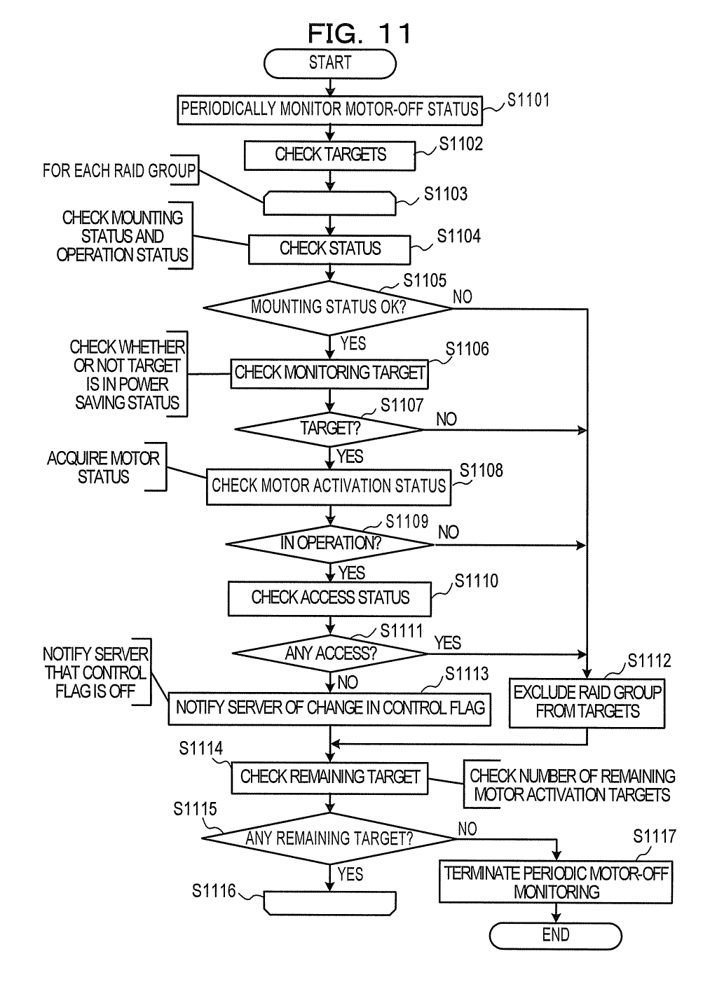

FIG. 11 illustrates a periodic motor-off monitoring process control operation in which the power supply control application 217 in the host server apparatus 202 gives an instruction on turn off the motors for the disks included in the storage apparatus 201 to which the host server apparatus 202 is connected.

This process is periodically started and executed by the power supply control application 217.

First, the power supply control application 217 starts a periodic motor-off monitoring process (Operation S1101). The power supply control application 217 checks the target storage apparatus 201, and each of the target RAID groups included in the storage apparatus 201 (Operation S1102).

Then, the power supply control application 217 repeatedly executes a series of process steps from Operations S1104 to S1115, via Operations S1103 and S1116, on each of the RAID groups in the storage apparatus 201 checked in Operation S1102. The power supply control application 217 thus executes a series of control process steps to give an instruction to turn off the motors for the disks belonging to each of the RAID groups.

In each repetition, the power supply control application 217 first checks the mounting status and operation status of the disks belonging to the target RAID group in the target storage apparatus 201 (Operation S1104). The check is achieved by inquiring about the value of the “Status” field for the corresponding RLU (RAID group) in the software cooperation configuration information held by the target storage apparatus 201.

Upon determining that the mounting status and the like are not OK (the “Status” field value=“Broken”, “Exposed”, or “Rebuild”) (the determination in Operation S1105 is NO), the power supply control application 217 determines that the RAID group be excluded from the targets to skip the accepting process (Operation S1112). The power supply control application 217 then shifts to processing of another monitoring target (Operation S1112→S1114).

Upon determining that the mounting status and the like are OK (the determination in Operation S1105 is YES), the power supply control application 217 checks whether or not the disks belonging to the target RAID group are operating in the power saving mode and can be a monitoring target (Operation S1106). The check is achieved by checking the value of the “ECO Flag” field for the corresponding RLU (RAID group) in the software cooperation configuration information held by the target storage apparatus 201.

Upon determining that the target RAID group is not a monitoring target (“ECO Flag” field value=“Off”) (the determination in Operation S1107 is NO), the power supply control application 217 determines that the RAID group be excluded from the targets to skip the accepting process (Operation S1112). The power supply control application 217 then shifts to processing of another monitoring target (Operation S1112→S1114).

Upon determining that the target RAID group is a monitoring target (“ECO Flag” field value=“On”) (the determination in Operation S1107 is YES), the power supply control application 217 further checks the operation status of the motors for the disks belonging to the target RAID group (Operation S1108). The check is achieved by checking the value of the “Motor Status” field for the corresponding RLU (RAID group) in the software cooperation configuration information held by the target storage apparatus 201.

Upon determining that the target RAID group is not in operation (“Motor Status” field value=value other than “On”) (the determination in Operation S1109 is NO), the power supply control application 217 determines that the RAID group be excluded from the targets to skip the accepting process (Operation S1112). The power supply control application 217 then shifts to processing of another monitoring target (Operation S1112→S1114).

Upon determining that the target RAID group is in operation (“Motor Status” field value=“On”) (the determination in Operation S1109 is YES), the power supply control application 217 checks how the host server apparatus 202 accesses the target RAID group (Operation S1110). The check is performed, for example, as follows. The power supply control application 217 manages a timestamp for the time when an access issued by the high-order application in the motor activation monitoring process shown in the operational flowchart in FIG. 8 is made. When the timestamp for the last access to the target RAID group indicates a time later than the current date and time by a given time, the power supply control application 217 determines that there is no other access to the target RAID group. Alternately, the power supply control application 217 determines that there is no other access to the target RAID group upon receiving the corresponding notification that there is no access from the high-order application to the target RAID group.

Upon determining that there is any other access to the target RAID group (the determination in Operation S1111 is YES), the power supply control application 217 determines that the RAID group be excluded from the targets to skip the accepting process (Operation S1112). The power supply control application 217 then shifts to processing of another monitoring target (Operation S1112→S1114).

Upon determining that there is no other access to the target RAID group (the determination in Operation S1111 is NO), the power supply control application 217 issues, to the power supply control section 209 in the target storage apparatus 201, a motor-off notification containing an instruction to change the value of the “Control Flag” field for the corresponding RLU (target RAID group) in the software cooperation configuration information in the target storage apparatus 201 to “Off”, in order to turn off the motors for the target RAID group (Operation S1113).

After the processing in Operation S1112 or S1113, the power supply control section 209 checks whether or not any other target storage apparatus 201 and target RAID group remain to be monitored (Operation S1114). Upon determining that there is any other monitoring target (the determination in Operation S1115 is YES), the power supply control section 209 continues to process the next monitoring target (Operation S1116). Upon determining that there is no other monitoring target (the determination in Operation S1115 is NO), the power supply control section 209 terminates the periodic motor-off monitoring process (Operation S1117).

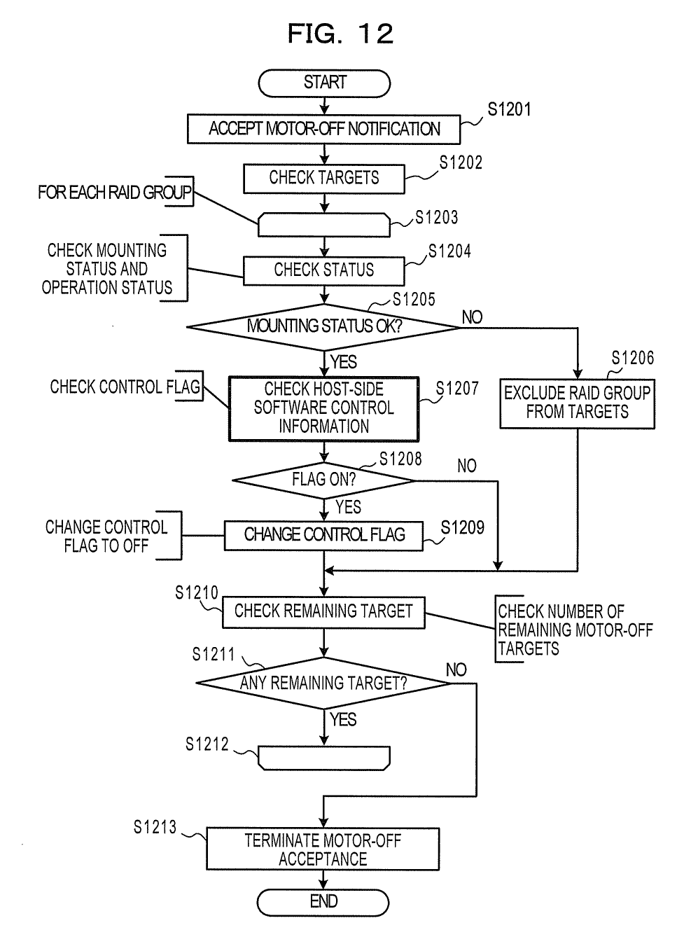

FIG. 12 illustrates a motor-off notification accepting process control operation performed by the power supply control section 209 (see FIG. 2) in the storage apparatus 201 upon accepting a motor-off notification relating to any of the RAID groups in the host server apparatus 202 as a result of the periodic motor-off monitoring process executed by the power supply control application 217 in the host server apparatus 202 as illustrated in FIG. 11; the control operation is required to instruct the apparatus to prepare to turn off the motors for the disks belonging to the RAID group.

First, the power supply control section 209 starts a motor-off notification accepting process (Operation S1201). The power supply control section 209 checks the RAID groups specified in the notification (Operation S1202).

Then, the power supply control section 209 executes repeatedly a series of process steps from Operations S1204 to S1211 via Operations S1203 and S1212 for each of the RAID groups corresponding to the accepted notification. The power supply control section 209 thus executes a series of control process steps to give an instruction to turn off the motors for the disks belonging to the RAID group.

In each repetition, the power supply control section 209 first checks the mounting status and operation status of the disks belonging to the target RAID group (Operation S1204). The check is achieved by checking whether or not the value of the “Status” field for the corresponding RLU (RAID group) in the software cooperation configuration information held by the storage apparatus 201 is “Available”.

Upon determining that the mounting status and the like are not OK (the determination in Operation S1205 is NO), the power supply control section 209 determines that the RAID group be excluded from the targets to skip the accepting process (Operation S1206). The power supply control section 209 then shifts to processing of another target RAID group (Operation S1206→S1210).

Upon determining that the mounting status and the like are OK (the determination in Operation S1205 is YES), the power supply control section 209 checks the status of control information in the host-side software for the disks belonging to the target RAID group (Operation S1207). The check is achieved by checking the value of the “Control Flag” field for the corresponding RLU (RAID group) in the software cooperation configuration information held by the storage apparatus 201.

Upon determining, as a result of the check, that the control information in the host-side software for the target RAID group does not indicate the control status (the “Control Flag” field value=value other than “On”) (the determination in Operation S1208 is NO), the power supply control section 209 shifts to processing of another target RAID group without performing any operation (Operation S1208→S1210).

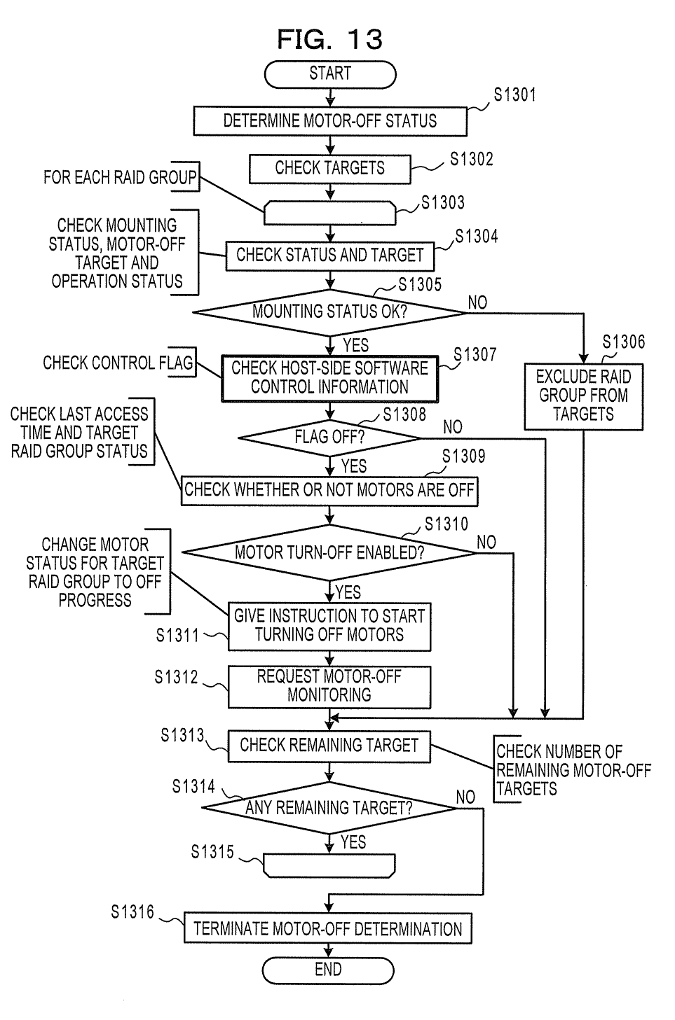

Upon determining, as a result of the check, that the control information in the host-side software for the target RAID group indicates the control status (the “Control Flag” field value=“On”) (the determination in Operation S1208 is YES), the power supply control section 209 first changes the value of the “Control Flag” field for the corresponding RLU (RAID group) in the software cooperation configuration information to “Off” in order to turn off the motors for the target RAID group (Operation S1209). Thus, the motors for the target RAID group are ready to be turned off. However, an actual motor-off instruction is issued in a motor-off determining process shown in an operational flowchart in FIG. 13 described below.

After the processing in Operation S1206 or S1209, the power supply control section 209 checks whether or not any other target RAID group remains to be processed (Operation S1210). Upon determining that any other target RAID group remains to be processed (the determination in Operation S1211 is YES), the power supply control section 209 continues to process the next processing target RAID group (Operation S1212). Upon determining that no other target RAID group remains to be processed (the determination in Operation S1211 is NO), the power supply control section 209 terminates the motor-off accepting process (Operation S1213).

FIG. 13 illustrates a motor-off determining process control operation in which the power supply control section 209 (see FIG. 2) in the storage apparatus 201 detects, in the RAID group in the apparatus, a disk for which the corresponding motor is ready to be turned off, and issues an instruction to turn off the motor.

The process in FIG. 13 is periodically started and executed by the power supply control section 209.

First, the power supply control section 209 starts a motor activation instruction notification accepting process (Operation S1301). The power supply control section 209 then checks each target RAID group (Operation S1302).

Then, the power supply control section 209 repeatedly executes a series of process steps from Operations S1304 to S1314, via Operations S1303 and S1315, on each of the RAID groups checked in Operation S1302. The power supply control section 209 thus executes a series of control process steps to give an instruction to turn off the motors for the disks belonging to the RAID group.

In each repeated process, the power supply control section 209 first checks the mounting status and operation status of the disks belonging to the target RAID group (Operation S1304). The check is achieved by checking whether or not the value of the “Status” field for the corresponding RLU (RAID group) in the software cooperation configuration information held by the storage apparatus 201 is “Available”, checking whether or not the value of the “Motor Status” field for the corresponding RLU (RAID group) in the software cooperation configuration information is “On”, and checking whether or not the value of the “ECO Flag” field for the corresponding RLU (RAID group) in the software cooperation configuration information, which field indicates whether or not the RAID group is intended to operate in the ECO mode is “On”.

Upon determining that the mounting status and the operation status are not OK (the determination in Operation S1305 is NO), the power supply control section 209 determines that the RAID group be excluded from the targets to skip the accepting process (Operation S1306). The power supply control section 209 then shifts to processing of another target RAID group (Operation S1306→S1313).

Upon determining that the mounting status and the operation status are OK (the determination in Operation S1305 is YES), the power supply control section 209 checks the status of control information in the host-side software for the disks belonging to the target RAID group (Operation S1307). The check is achieved by checking the value of the “Control Flag” field for the corresponding RLU (RAID group) in the software cooperation configuration information held by the storage apparatus 201.

Upon determining, as a result of the check, that the control information in the host-side software for the target RAID group indicates the control status (the “Control Flag” field value=“On”) (the determination in Operation S1308 is NO), the power supply control section 209 shifts to processing of another target RAID group without performing any operation (Operation S1308→1313).

Upon determining, as a result of the check, that the control information in the host-side software for the target RAID group does not indicate the control status (the “Control Flag” field value=“Off”) (the determination in Operation S1308 is YES), the power supply control section 209 checks access elements other than the motor-off notification from the host server apparatus 202, that is, checks the physical status again and checks the final access time that may have been changed by an access from another host server apparatus 202 or the like in order to check whether or not the motor in the target RAID group is really allowed to be turned off. These checks are achieved by checking the value of the “Status” field for the corresponding RLU (RAID group) in the software cooperation configuration information held by the storage apparatus 201 is “Available” and checking the value of the “Last Access” field. Moreover, the power supply control section 209 checks whether or not all the contents of the cache memory 208 (see FIG. 2) are reflected in the disk. The disk is not allowed to be turned off until the disk has passed these checks (the above-described motor-off check corresponds to Operation S1309).

Upon determining, as a result of the check, that the motors not be turned off (the determination in Operation S1310 is NO), the power supply control section 209 shifts to processing of another target RAID group without performing any operation (Operation S1310→S1313).

Upon determining, as a result of the check, that the motors be turned off (the determination in Operation S1310 is YES), the power supply control section 209 issues an instruction to start turning off the motors belonging to the target RAID group. The power supply control section 209 changes the value of the “Motor Status” field for the corresponding RLU (RAID group) in the software cooperation configuration information to “Off Progress” (Operation S1311). Then, the motor-off process is executed on the motors.

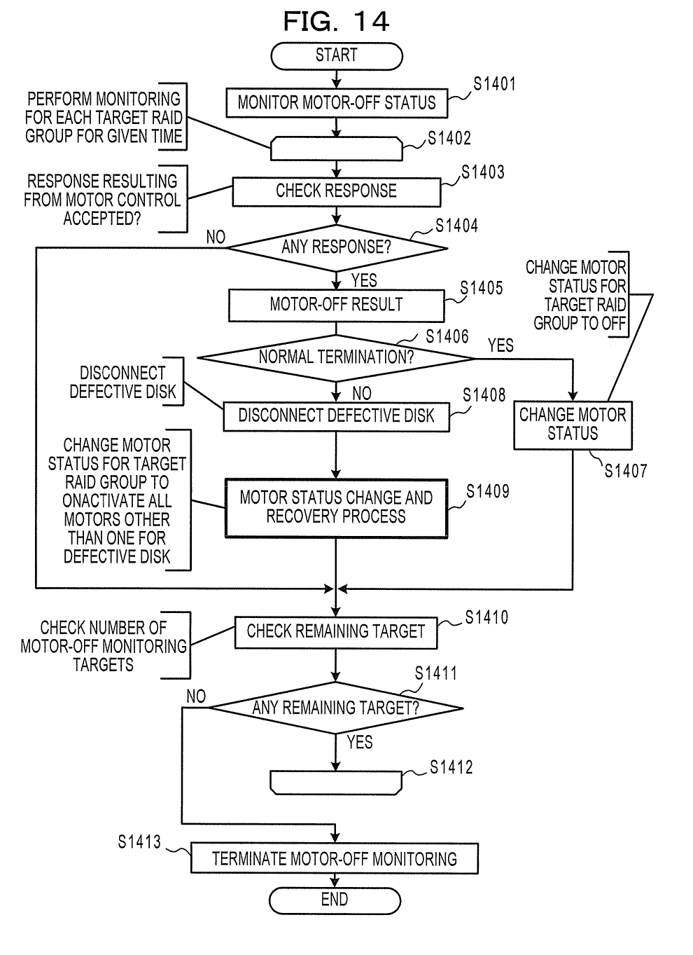

Moreover, the power supply control section 209 requests the apparatus to perform monitoring to check whether or not the motor-off process has been completed in connection with a motor-off monitoring process illustrated in FIG. 14 described below (Operation S1312).

After the processing in Operation S1306, S1308, S1310, or S1312, the power supply control section 209 checks whether or not any other target RAID group remains to be processed (Operation S1313). Upon determining that any other target RAID group remains to be processed (the determination in Operation S1314 is YES), the power supply control section 209 continues to process the next processing target RAID group (Operation S1315). Upon determining that no other target RAID group remains to be processed (the determination in Operation S1314 is NO), the power supply control section 209 terminates the motor-off determining process (Operation S1316).

FIG. 14 illustrates a motor-off monitoring process control operation in which the power supply control section 209 in the storage apparatus 201 processes a response resulting from the motor control performed according to the motor-off start instruction issued in Operation S1311 during the motor-off determining process illustrated in FIG. 13.

First, the power supply control section 209 starts a motor-off monitoring process (Operation S1401). The power supply control section 209 repeatedly executes a series of process steps from Operations S1403 to S1411, via Operations S1402 and S1412, on each of the specified target RAID groups so that the same target RAID group is processed at least once for a given time. The power supply control section 209 thus monitors the disks in each target group for a given time.

In each repetition, the power supply control section 209 first checks whether or not a response has been obtained from the motor control function for the disks belonging to the target RAID group (Operation S1403).

Upon determining, as a result of the check, that the response has not been accepted (the determination in Operation S1404 is NO), the power supply control section 209 shifts to processing of the next monitoring target (Operation S1410).

Upon determining, as a result of the check, that the response has been accepted, the power supply control section 209 receives the result of the motor-off process from the motor control function to determine the contents of the result (Operation S1405).

As a result, upon determining that the motor activation process has completed normally (the determination in Operation S1406 is YES), the power supply control section 209 changes the value of the “Motor Status” field for the corresponding RLU (RAID group) in the software cooperation configuration information from “Off Progress”, indicating that the motor-off process is in progress, to “Off”, indicating that the motors are off (Operation S1407). Thereafter, the power supply control section 209 shifts to processing of the next monitoring target (Operation S1407→Operation S1410).

Upon determining that the motor-off process has failed to complete normally (the determination in Operation S1406 is NO), the power supply control section 209 removes the defective disk from the processing targets. Simultaneously with the process of removing the defective disk from the processing targets, the power supply control section 209 suspends the motor-off process executed on the other disks in the RLU (RAID group). If the motors are off, the motor-on process is activated. Moreover, if the storage apparatus has no hot spare disk, the power supply control section 209 further changes the value of the “Status” field for the corresponding RLU (RAID group) in the software cooperation configuration information held in the storage apparatus 201, to “Exposed”, indicating the presence of the defective disk. Furthermore, if a hot spare disk is present, the power supply control section 209 changes the value to “Rebuild”, indicating that the recovery process is executed using the redundant normal disk (Operation S1408).

Thereafter, the power supply control section 209 changes the value of the “Motor Status” field for the corresponding RLU (RAID group) in the software cooperation configuration information to “On” in association with the specifications of the system to which the present embodiment is applied.

After the processing in Operation S1404, S1407, or S1409, the power supply control section 209 checks whether or not any other target RAID group remains to be monitored (Operation S1410). Upon determining that any other target RAID group remains to be monitored (the determination in Operation S1411 is YES), the power supply control section 209 continues to monitor the next monitoring target RAID group (including itself) (Operation S1412). Upon determining that no other target RAID group remains to be monitored (the determination in Operation S1411 is NO), the power supply control section 209 terminates the motor-off monitoring process (Operation S1413).

As described above, the power supply control section 209 of the storage apparatus 201 can positively and appropriately turn off the disks in the RAID group in the storage apparatus 201 which is not accessed by the host server apparatus 202.

The case has been described in which in the configuration in FIG. 2, the host server apparatus 202 and the storage apparatus 201 are connected together via the network such as the LAN 203 or the like. In this configuration, the power supply control application 217 in the host server apparatus 202 and the power supply control section 209 in the storage apparatus 201 cooperate in optimally controllably turning on and off the motors for the disks in the RAID group, which correspond to a logical volume.

In contrast, a case will be described in which in the configuration in FIG. 2, the host server apparatus 202 and the storage apparatus 201 are connected together via the channel path 203-2. In this case, the power supply control driver 218 in the host server apparatus 202 and the power supply control section 209 in the storage apparatus 201 cooperate in optimally controllably turning on and off the motors for the disks in the RAID group. This operation is basically the same as that in the case of the power supply control application 217. However, the following functions are mainly implemented.

1. If a response of a specific sense to an access to the storage apparatus 201 indicates that the motors are ready to be turned on, the power supply control driver 218 retries a host access to the storage apparatus 201.

2. While retrying a host access to the storage apparatus 201, the power supply control driver 218 returns a sense response of a notification level to the host server apparatus 202 to prevent the path from being disconnected. The power supply control driver 218 thus allows the host server apparatus 202 to wait.

A series of operations performed as a result of an access made to the storage apparatus 201 by the host server apparatus 202 are as follows.

1) The power supply control driver 218 recognizes an access generated by the host server apparatus 202.

2) The power supply control driver 218 executes a host access to the storage apparatus 201.

3) If the storage in the access destination is not in the power saving status and is accessible, then the access process is executed.

4) If the storage in the access destination is in the power saving status and is inaccessible, then in response to the access, the storage apparatus 201 cancels the power saving status of the disk. The storage apparatus 201 then starts turning on the motor for the disk.

5) The storage apparatus 201 holds the access for a given time (the storage apparatus 201 executes an access holding operation), and then returns a sense response indicating that the motor-on process is being executed.

6) Upon receiving the sense response indicating that the motor-on process is being executed, the power supply control driver 218 retries an access to the storage apparatus 201 without returning the sense response to the host server apparatus 202.

7) Before timeout occurs, that is, a processing duration permitted by the power supply control driver 218 expires, the process steps from 4) to 6) are repeatedly executed until the motors are turned on.

In the above-described embodiments, the logical volume corresponds to the RAID group. However, the present invention is not limited to this aspect.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling a logical volume including a plurality of storage media in a storage system, the method comprising:
issuing an instruction for access to the logical volume;
determining a power supply status of the storage media making up the logical volume for which the access instruction is issued;
giving an instruction to change the power supply status of the storage media making up the logical volume, when the power supply status determining operation determines that the logical volume is in a power supply status in which the logical volume is inaccessible;
managing the access instruction until the logical volume becomes accessible;
controlling the power supply status of a storage medium corresponding to a redundancy of the logical volume including all the storage media making up the logical volume, based on the power supply status change instruction;
transmitting a response indicating that the logical volume is accessible, when the logical volume becomes accessible as a result of the control of the power supply status; and
executing the access to the logical volume based on the response.

2. The method of controlling the storage system according to claim 1, wherein power supply control is performed on all the storage media making up the logical volume.

3. The method of controlling the storage system according to claim 1, wherein an access status of the logical volume is managed, and
the power supply to the storage media making up the logical volume is controlled based on the access status.

4. The method of controlling the storage system according to claim 3, wherein a power supply control schedule for the storage media making up the logical volume is created based on the access status of the logical volume, and
the power supply to the storage media making up the logical volume is controlled based on the power supply control schedule.

5. The method of controlling the storage system according to claim 3, wherein when the access status of the logical volume indicates that the logical volume is ready to be activated, a response indicating that the logical volume is ready to be activated is issued in connection with the issuance of the access instruction.

6. A storage system comprising:
a server; and
a storage apparatus accessing a logical volume comprising a plurality of storage media, based on an instruction from the server,
wherein the server comprises:
an access instruction issuing section issuing an instruction to access the logical volume;
a power supply status determining section determining a power supply status of the storage media making up the logical volume for which the access instruction is intended;
a power supply control instructing section which gives an instruction to set the power supply status such that the logical volume is accessible, when the power supply status determining section determines that the logical volume is in a power supply status in which the logical volume is inaccessible; and
an access instruction managing section managing the access instruction until the logical volume becomes accessible, and
the storage apparatus comprises:
an instruction receiving section receiving the access instruction and the power supply status change instruction receiving from the server;
a power supply control section controlling the power supply status of a storage medium corresponding to an redundancy of the logical volume including all the storage media making up the logical volume, based on the power supply status change instruction;
an accessibility responding section transmitting a response indicating that the logical volume is accessible, to the server; and
an access executing section executing the access to the logical volume based on the access instruction.

7. The storage system according to claim 6, wherein the power supply control section gives an instruction to change the power supply status of all the storage media making up the logical volume.

8. The storage system according to claim 6, further comprising an access managing section managing an access status of the logical volume,
wherein the power supply control section controls the power supply to the storage media making up the logical volume based on the access status.

9. The storage system according to claim 8, further comprising a power supply control schedule creating section creating a power supply control schedule for the storage media making up the logical volume, based on the access status of the logical volume managed by the access managing section,
wherein the power supply control section controls the power supply to the storage media making up the logical volume, based on the power supply control schedule.

10. The storage system according to claim 6, further comprising a power supply status notifying section notifying the server of the power supply status of the storage media making up the logical volume.

11. The storage system according to claim 10, further comprising a ready-for-activation status response issuing section issuing a response indicating that the logical volume is ready to be activated in connection with the issuance of the access instruction when the power supply status indicates that the logical volume is ready to be activated.

12. A storage apparatus comprising a logical volume comprising a plurality of storage media, the storage apparatus comprising:
an access instruction receiving section receiving, from a server, an instruction to access the logical volume;
an access executing section executing an access to the logical volume based on the access instruction; and
a power supply control section which, if the logical volume to be accessed is inaccessible, changes a power supply status of a storage medium corresponding to redundancy of the logical volume.

13. The storage apparatus according to claim 12, wherein upon receiving the power supply status change instruction from the server, the power supply control section changes the power supply status of the storage media.

14. The storage apparatus according to claim 12, wherein the power supply control section controls the power supply to all the storage media making up the logical volume.

15. The storage apparatus according to claim 12, further comprising an access managing section managing an access status of the logical volume,
wherein the power supply control section controls the power supply to the storage media making up the logical volume based on the access status.

16. The storage apparatus according to claim 15, further comprising a power supply control schedule creating section creating a power supply control schedule for the storage media making up the logical volume, based on the access status of the logical volume managed by the access managing section,
wherein the power supply control section controls the power supply to the storage media making up the logical volume, based on the power supply control schedule.

17. The storage apparatus according to claim 12, further comprising a power supply status notifying section notifying the server of the power supply status of the storage media making up the logical volume.

18. The storage apparatus according to claim 17, further comprising a ready-for-activation status response issuing section issuing a response indicating that the logical volume is ready to be activated in connection with the issuance of the access instruction when the power supply status indicates that the logical volume is ready to be activated.

19. The storage apparatus according to claim 12, further comprising a re-access request notifying section which, if the logical volume is inaccessible, notifies the server of a re-access request until the logical volume becomes accessible.
